(19) United States
(12) Patent Application Publication
(10) Pub. No.: US 2011/0093728 A1
(43) Pub. Date: Apr. 21, 2011

(54) COMPUTER SYSTEM AND CONTROL METHOD THEREOF

(75) Inventor: Kumarbrata DAS, Gyeonggi-do (KR)

(73) Assignee: SAMSUNG ELECTRONICS CO., LTD., Gyeonggi-Do (KR)

(21) Appl. No.: 12/900,546

(22) Filed: Oct. 8, 2010

(30) Foreign Application Priority Data
Oct. 15, 2009 (KR) 10-2009-0098380

(51) Int. Cl. G06F 1/32; G06F 11/30

(52) U.S. Cl. 713/320; 713/340

(57) ABSTRACT

A computer system and a control method thereof which activates/inactivates a power management mode depending on a performance of a communication operation by a communication unit to thereby increase a life of a battery and/or retain a high data transmission rate when communicating. The computer system includes a communication unit which receives operating power and performs a network communication with an external device; and a controller which identifies a performance of a communication operation of the communication unit and controls the communication unit to reduce a consumption of the operating power supplied to the communication unit if the communication unit does not perform the communication operation, and controls the communication unit not to reduce the consumption of the operating power supplied thereto if the communication unit performs the communication operation.

### CLAIM OF PRIORITY

This application claims priority from Korean Patent Application No. 10-2009-0098380, filed on Oct. 15, 2009 in the Korean Intellectual Property Office, the disclosure of which is incorporated herein by reference in its entirety.

### BACKGROUND OF THE INVENTION

1. Field of the Invention

The present invention relates to a computer system and a control method thereof. More particularly, the present invention relates to a computer system and a control method thereof to reduce the consumption of power and extend a life of a battery of the computer system.

2. Description of the Related Art

Peripheral Component Interconnect Express (PCIe) bus can be found in servers, desktop computers, mobile PCs and laptop computers. The PCIe can be thought of as a high speed serial replacement of a conventional parallel PCI/PCI-X bus. PCIe devices communicate through a logical connection called a link, which is a point-to-point communication channel between two PCIe ports in order to permit transmitting and receiving data.

Active State Power Management (ASPM) allows the power of individual serial Links in a PCIe devices to be incrementally reduced as a Link becomes less active. The ASPM has been incorporated into the PCIe as a method to manage power consumption of a battery more efficiently. Accordingly, in electronic devices such as a laptop computer and a computer system under a battery mode, an activated ASPM sharply increases life of the battery. Conversely, an inactivated ASPM badly reduces the life of the battery.

A mobile computer platform, such as a netbook, notebook, tablet or laptop computer may include a plurality of devices using the PCIe bus for data transmission. When a system incorporating the PCIe bus is designed, the ASPM for the PCIe-based devices is activated or inactivated.

However, there arises a problem in both an activated and an inactivated ASPM. The problem is that the life of the battery is reduced under the inactivated ASPM, whereas the data transmission rate becomes lower under the activated ASPM.

### SUMMARY OF THE INVENTION

Accordingly, one or more exemplary embodiments of the present invention provide a computer system and a control method thereof which activates/inactivates a power management mode by monitoring performance of a communication operation by a communication unit, thereby resulting in an increase a life of a battery.

According to an exemplary embodiment of the present invention, there is provided a computer system including a communication unit which receives operating power and performs a network communication with an external device; and a controller that identifies a performance of a communication operation of the communication unit and controls the communication unit to reduce an amount of the operating power supplied to the communication unit when the communication unit does not perform the communication operation, and controls the communication unit so as not to reduce the amount of the operating power supplied thereto when the communication unit performs the communication operation.

According to an exemplary aspect of the invention, the operating power of the communication unit is supplied under a power management mode, wherein the controller activates the power management mode to reduce the amount of the operating power supplied to the communication unit, and the controller inactivates the power management mode so as not to reduce the amount of the operating power supplied to the communication unit that would adversely impact the data transmission rate.

According to another exemplary aspect of the invention, the communication unit performs the communication operation by using a peripheral component interconnect express (PCIe) bus, and the power management mode comprises an active state power management (ASPM) mode.

According to yet another exemplary aspect of the invention, the computer system further includes a battery which supplies the operating power to the communication unit.

In addition, the communication unit performs a wired network communication with an external device, and the controller identifies whether or not a cable is connected to the communication unit to perform the wired network communication and identifies the performance of the communication operation of the communication unit.

Moreover, the communication unit performs a wireless network communication with an external device, and the controller identifies whether or not the communication unit is connected to an access point of a wireless network and identifies the performance of the communication operation of the communication unit.

According to another exemplary embodiment of the present invention, there is a control method of a computer system which includes a communication unit receiving operating power and performing a network communication with an external device, wherein the control method comprises identifying whether or not the communication unit performs a communication operation. If the communication unit does not perform the communication operation, the communication unit is controlled to reduce the amount of the operating power supplied to the communication unit when the communication unit does not perform the communication operation, and not to reduce the amount of the operating power supplied to the communication unit when the communication unit performs the communication operation.

According to an exemplary aspect of the present invention, the operating power of the communication unit is supplied under a power management mode, and the controlling the communication unit includes activating the power management mode to reduce the amount of the operating power supplied to the communication unit and inactivating the power management mode not to reduce the amount of the operating power supplied to the communication unit.

According to still another exemplary aspect of the present invention, the communication unit performs the communication operation by using a peripheral component interconnect express (PCI-E-bus, and the power management mode comprises an active state power management (ASPM) mode.

The control method further includes providing a battery which supplies the operating power to the communication unit.

The communication unit preferably performs a wired network communication with an external device, and the identifying the performance of the communication operation of the communication unit includes identifying whether or not a cable is connected to the communication unit to perform the wired network communication.

The communication unit performs a wireless network communication with an external device, and the identifying the performance of the communication operation of the communication unit includes identifying whether or not the communication unit is connected to an access point of a wireless network.

### BRIEF DESCRIPTION OF THE DRAWINGS

The above and/or other exemplary aspects of the present invention will become apparent and more readily appreciated from the following description of the exemplary embodiments, taken in conjunction with the accompanying drawings, in which:

FIG. 1 is a control block diagram of a computer system according to an exemplary embodiment of the present invention;

FIG. 2 is a flowchart of a control process of the computer system according to an exemplary embodiment of the present invention;

FIG. 3 is a flowchart of a control process of a computer system according to another exemplary embodiment of the present invention; and

FIG. 4 is a flowchart of a control process of a computer system according to yet another exemplary embodiment of the present invention.

### DETAILED DESCRIPTION

Below, exemplary embodiments will be described in detail with reference to the accompanying drawings so as to be realized by a person having ordinary knowledge in the art without undue experimentation. The exemplary embodiments of the presently claimed invention may be realized in many various forms without being limited to the exemplary embodiments set forth herein. Descriptions of well-known structures and functions may be omitted for clarity when their inclusion might obscure appreciation of the subject matter of the present invention by a person of ordinary skill in the art, and like reference numerals typically refer to like elements throughout.

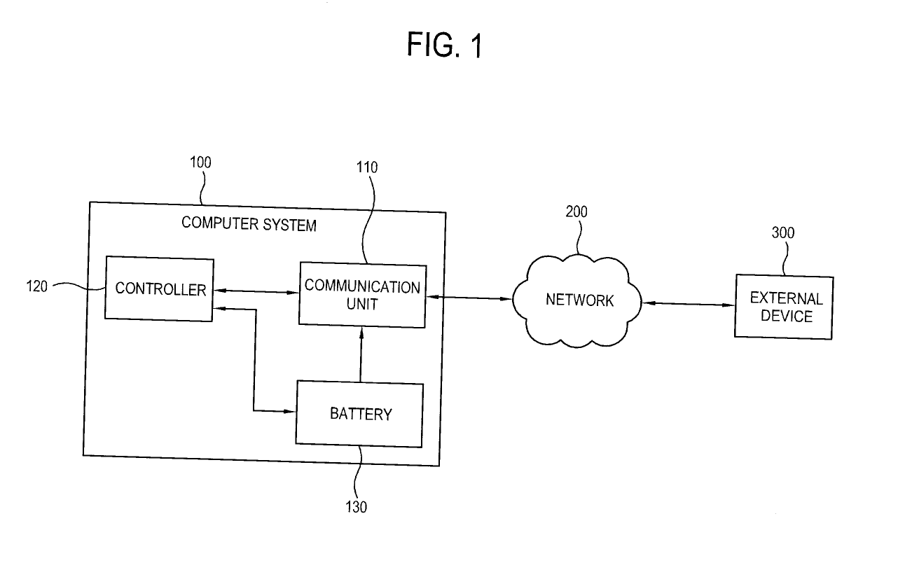

FIG. 1 is a control block diagram of a computer system according to an exemplary embodiment of the present invention.

As illustrated in FIG. 1, the computer system 100 communicates with an external device 300 via a network 200.

The computer system 100 may include, for example a personal computer (PC) such as a desktop computer, notebook, tablet or laptop computer, or even a PDA, just to name a few possible examples. The computer system 100 may further include any type of devices equipped with functions similar to those of a PC such as a smartbook, a mobile Internet device or a netbook as well as a typical PC.

The network 200 includes a wired or wireless network. The wired network may include a local area network (LAN) while the wireless network may include a wireless local area network (WLAN).

The external device 300 includes any device which is capable of communicating with the computer system 100 in a wired or wireless network 200.

The computer system 100 preferably includes a communication unit 110, a controller 120 and a battery 130.

The communication unit 110 communicates with the external device 300 through the network 200. The communication unit 110 may include a network card or network chip.

The communication unit 110 receives operating power and performs a communication operation. The computer system 100 may further include a power supply (not shown) to supply operating power to the communication unit 110, as the computer can optionally be powered from an alternating current source, or the alternating current source can be used by a battery charging module (not shown). The power supply supplies power to configurations of the computer system 100 including the communication unit 110. The power supply may convert commercial AC power supplied from the outside into operating power to be supplied to the communication unit 110.

The battery 130 has a predetermined battery capacity to charge power and is charged by power supplied from the power supply. The battery 130 may supply operating power to the communication unit 110 as an auxiliary power source of the power supply. The computer system 100 may further include a microcomputer (not shown) to control charging of the battery 130.

The power supply (not shown) and the battery 130 may selectively supply power to the communication unit 110 according to a control of the controller 120. For example, the controller 120 controls the power supply to supply power upon supply of commercial AC power from the outside, and controls the battery 130 to supply power if the commercial AC power is not supplied from the outside.

With continued reference to FIG. 1, the controller 120 identifies whether or not the communication unit 110 performs a communication operation.

If the communication unit 110 includes a wired network card or wired network chip, the controller 120 identifies whether a wired network cable is connected to the communication unit 110 to identify the communication operation of the communication unit 110. In other words, if the wired network cable is connected to the communication unit 110, then the controller 120 determines that the communication unit 110 performs the communication operation. If the network cable is not connected to the communication unit 110, the controller 120 may determine that the communication unit 110 does not perform the communication operation. Thus the presence or absence of a network cable can be the determinant factor regarding whether or not the communication unit performs the communication operation.

If the communication unit 110 includes a wireless network card or wireless network chip, the controller 120 identifies whether or not the communication unit 110 is connected to an access point of the wireless network in order to identify the communication operation of the communication unit 110. That is, if the communication unit 110 is connected to the access point of the wireless network, the controller 120 determines that the communication unit 110 performs the communication operation. If the communication unit 110 is not connected to the access point of the wireless network, the controller 120 may determine that the communication unit 110 does not perform the communication operation.

The controller 120 may identify the communication operation of the communication unit 110 and control the communication unit 110 to reduce consumption of power so as to reduce an amount of the operating power supplied to the communication unit 110 if the communication unit 110 does not perform the communication operation, and control the communication unit 110 so as not to reduce the amount of the operating power supplied to the communication unit 110 if the communication unit 110 performs the communication operation.

The operating power of the communication unit 110 is preferably supplied under a power management mode. The controller 120 may activate the power management mode to reduce the amount of the operating power supplied to the communication unit 110, and inactivate the power management mode so as not to reduce the amount of the operating power supplied to the communication unit 110 in order to prevent the data transmission rate from being reduced.

According to the present invention, the communication unit 110 preferably performs the communication operation by using a peripheral component interconnect express (PCIe) bus.

The power management mode may preferably include an active state power management (ASPM) mode.

The controller 120 may include a combination of hardware and software, and firmware. The controller 120 may be programmed with executable code on a machine readable medium for execution by a central processing unit (CPU) (not shown), a main memory (not shown), a basic input/output system memory (BIOS), a hard disc drive or other type of medium (not shown) and a controller hub (not shown) as hardware.

The main memory may include a random access memory (RAM) as a volatile memory while the BIOS may include a read only memory (ROM) as a non-volatile memory. The HDD may include a magnetic or flash memory as a non-volatile memory.

The controller hub acts as an interface between the CPU, main memory, BIOS memory and the HDD for data transmission. The controller hub may include a northbridge (not shown) for data transmission, or a southbridge (not shown) for low speed data transmission or an I/O controller hub (ICH) (not shown).

The controller 120 preferably includes a BIOS (not shown) and an operating system (OS) (not shown) as computer programs on which an application can be executed.

The BIOS is stored in the BIOS memory while the OS is stored in the HDD. The computer program is a series of codes to execute the CPU and loaded, in whole or in part, into the main memory. The CPU reads and executes the codes of the loaded computer program and performs a function of the computer program.

The BIOS is programmed to boot the computer system 100 upon power-on of the computer system 100. Upon booting, the OS is loaded into the main memory. The BIOS is programmed to recognize and control hardware forming the computer system 100, e.g., hardware forming the communication unit 110.

Depending on the identification of the communication operation of the communication unit 110, according to an exemplary aspect of the present invention, the BIOS may activate or inactivate the power management mode to supply power to the communication unit 110. That is, if the communication unit 110 does not perform the communication operation, the BIOS may activate the power management mode. If the communication unit 110 performs the communication operation, the BIOS may inactivate the power management mode.

The OS is programmed to manage resources of hardware and software of the computer system 100. The function of the OS includes allocation of the main memory, file management, input/output control for the device, and execution control of a program such as a communication program. The OS may include, e.g., Windows of Microsoft Corporation.

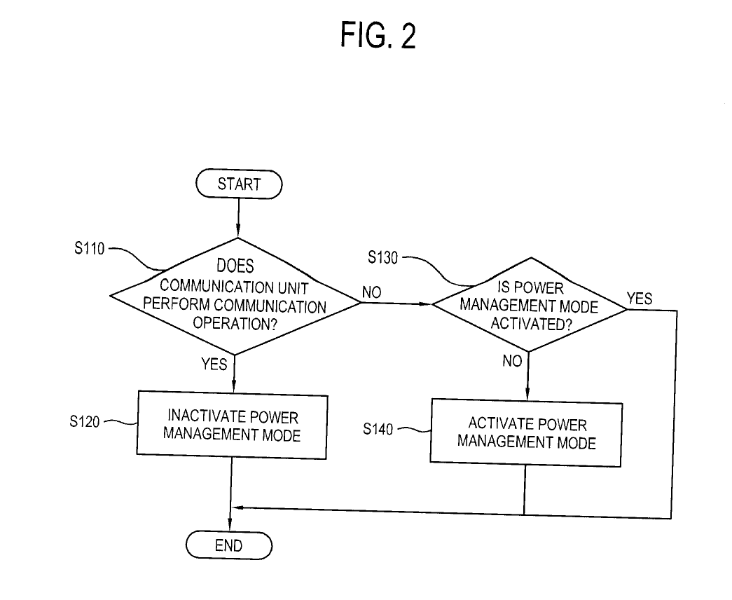

FIG. 2 is a flowchart of a control process of the computer system according to an exemplary embodiment of the present invention.

When the computer system 100 is booted, at (S110) the power management mode may be activated or inactivated. The controller 120 identifies whether the communication unit 110 performs the communication operation. If at (S110) it is identified that the communication unit 110 performs the communication operation, then at (S120) the controller 120 controls the power management mode to be inactivated when power is supplied to the communication unit 110. If at (S110) it is identified that the communication unit 110 does not perform the communication operation, then at (S130) the controller 120 identifies whether the power management mode is activated. If at (S130) the power management mode is not activated, then at (S140) the controller 120 activates the power management mode.

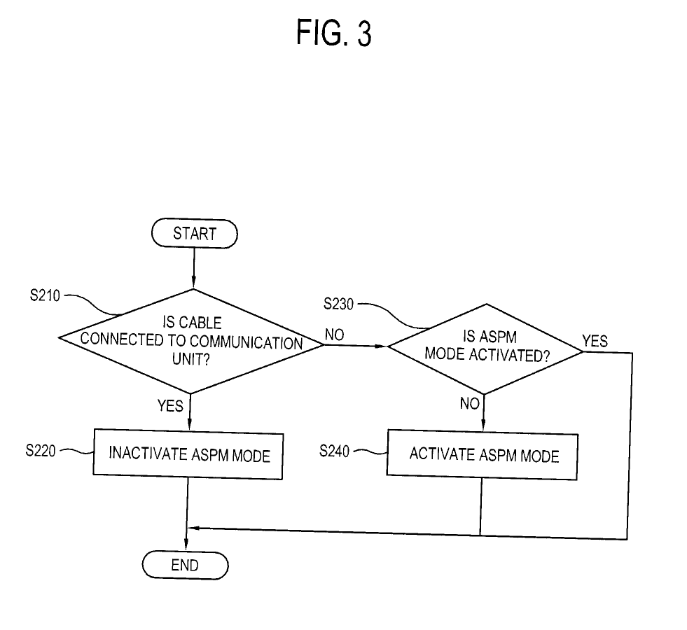

FIG. 3 is a flowchart of a control process of a computer system according to another exemplary embodiment of the present invention.

In another exemplary embodiment of the present invention, the communication unit of the computer system performs a wired network communication and data are transmitted by a PCIe bus.

When the computer system 100 according to the exemplary embodiment is booted, the power management mode may be activated or inactivated.

At (S210), the controller 120 identifies whether or not a wired network cable is connected to the communication unit 110. If at (S210) the cable is connected to the communication unit 110, then at (s120) the controller 120 controls the ASPM mode to be inactivated when power is supplied to the communication unit 110. If at (S210) the cable is not connected to the communication unit 110, then at (S230) the controller 120 identifies whether the ASPM mode is activated. If at (S230) the ASPM mode is not activated, then at (S240) the controller 120 activates the ASPM mode.

According to the present invention, a high speed Ethernet controller automatically enters into a lower power mode and reduces power consumption during the inactivated time. Giga bit and high speed Ethernet controller have L1 ASPM activated, and automatically enters a low power mode and reduces power consumption during inactivation time in the interface by using the conventional PCIe bus. However, long L1 delay time affects a network adaptor and a network packet from another network is processed or reacts. If the ASPM is activated, the network speed significantly slows down compared to the inactivated state. Due to the foregoing problem, a life of the battery is reduced if the device is designed to inactivate the ASPM.

As shown in FIGS. 2 and 3, the computer system 100 according to an exemplary aspect of the present invention identifies the communication operation of the communication unit 110, and does not execute the power management mode if the communication unit 110 performs the communication operation. Thus, without decrease in the network speed, a user may conveniently use the computer system 100. If the communication unit 110 does not perform the communication operation, the computer system 100 according to the present invention executes the power management mode to extend the life of the battery 130.

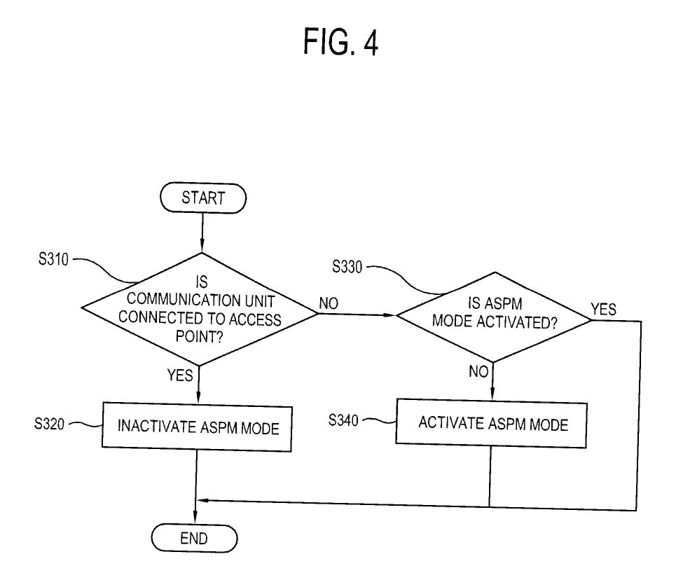

FIG. 4 is a flowchart of a control process of a computer system according to another exemplary embodiment of the present invention.

In another exemplary embodiment of the present invention, the communication unit 110 performs a wireless network communication and data are transmitted by a PCIe bus.

When the computer system 100 according to the exemplary embodiment is booted, the power management mode may be activated or inactivated.

With reference to FIG. 4, at (S310) the controller 120 identifies whether or not the communication unit 110 is connected to an access point of the wireless network. If at (S310) the communication unit 110 is connected to the access point of the wireless network, then at (S320) the controller 120 controls the ASPM mode to be inactivated when power is supplied to the communication unit 110. If at (S310) the communication unit 110 is not connected to the access point of the wireless network, then at (S330) the controller 120 identifies whether the ASPM mode is activated. If at (S330) the ASPM mode is not activated, then at (S340) the controller 120 activates the ASPM mode.

Some advantages of the computer system 100 according to the present invention becomes more apparent in following scenarios, such as a user who wishes a fast network communication speed when he/she performs wired or wireless network communication with an external device and downloads materials and/or accesses the Internet in the circumstances where he/she does not receive external AC power.

For example, in a conventional computer system in which the power management mode is activated always, the power management mode is activated even if the communication unit performs the communication operation. In such a scenario, the network communication speed becomes slower, and the user feels inconvenienced. However, in the computer system 100 according to the present invention, the communication unit 110 performs a wired or wireless network communication, and the controller 120 inactivates the power management mode of the communication unit 110 to thereby provide a fast network communication speed.

In another scenario, when the user accesses the computer system in a location where he/she may not perform wired or wireless network communication, and/or does not receive external AC power such as while in an airplane, a user may wish to execute operations such as document preparation or multimedia playing. In this scenario, the life of the battery 130 is quite important, and there is little concern regarding a data transmission rate as there is no communication external to the device.

In a conventional computer system in which the power management mode is inactivated always, the power management mode is inactivated even if the communication unit 120 does not perform the communication operation. Then, a power consumption speed becomes fast, and the life of the battery is shortened.

However, in such a scenario, in the computer system 100 according to the present invention, the communication unit 110 does not perform the wired or wireless network communication, the controller 120 activates the power management mode of the communication unit 110 to extend the life of the battery 130 and enables a user to use the computer system 100 for a relatively longer time than if power management had not been activated.

The control method of the computer system which includes the communication unit receiving operating power and performing a network communication with an external device comprises identifying whether the communication unit performs the communication operation; and controlling the communication unit to reduce the amount of the operating power supplied to the communication unit if the communication unit does not perform the communication operation and controlling the communication unit not to reduce the amount of the operating power supplied to the communication unit if the communication unit performs the communication operation.

The control method of the computer system is the same as that described in the control process of the computer system. Thus, repetitive description will be avoided here.

As described above, a computer system and a control method thereof according to the present invention activates/inactivates a power management mode depending on a performance of a communication operation by a communication unit and improves a data transmission speed or extends a life of a battery as necessary.

The above-described methods and modes of operation according to the present invention can be realized in hardware or as software or computer code that can be stored in a recording medium such as a CD ROM, a RAM, thumbnail drive, a floppy disk, a flash storage, a hard disk, or a magneto-optical disk or downloaded over a network, so that the methods described herein can be executed by such software using a general purpose computer, or a special processor or special microprocessor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

Although a few exemplary embodiments have been shown and described, it will be appreciated by those skilled in the art that changes may be made in these exemplary embodiments without departing from the principles and spirit of the invention, the scope of which is defined in the appended claims and their equivalents.

What is claimed is:

1. A computer system, including:
a communication unit for receiving operating power and performing a network communication operation with an external device; and
a controller for monitoring operation of the communication unit and controlling the amount of operating power supplied to the communication unit.

2. The computer system according to claim 1, wherein the controlling of the operating power supplied to the communication unit is managed by a power management mode,
wherein based upon predetermined operating conditions of computer system, the controller activates the power management mode to reduce an amount of the operating power supplied to the communication unit, and
the controller inactivates the power management mode not to reduce the amount of the operating power supplied to the communication unit.

3. The computer system according to claim 1, wherein the controller reduces an amount of operating power supplied to the communication unit when the communication unit does not perform the communication operation, and the controller does not reduce the amount of the operating power supplied thereto if the communication unit performs the communication operation.

4. The computer system according to claim 2, wherein the predetermined operating conditions include the controller inactivates the power management mode when the communication unit performs a communication operation, and wherein the controller activates the power management mode when the communication unit does not perform a communication operation.

5. The computer system according to claim 4, wherein when the power management mode is inactive the data transmission rate is not decreased to reduce consumption of power.

6. The computer system according to claim 4, wherein when the power management mode is active the data transmission rate is reduced to extend battery life of a battery supplying power to the communication unit.

7. The computer system according to claim 2, wherein the communication unit performs the communication operation utilizing a peripheral component interconnect express (PCIe) bus, and the power management mode comprises an active state power management (ASPM) mode.

8. The computer system according to claim 1, further including a battery that supplies the operating power to the communication unit.

9. The computer system according to claim 1, wherein the communication unit performs a wired network communication operation with an external device, and the controller determines whether or not a cable is connected to the communication unit to perform the wired network communication operation and identifies the performance of the communication operation of the communication unit.

10. The computer system according to claim 1, wherein the communication unit performs a wireless network communication operation with an external device, and the controller determines whether or not the communication unit is connected to an access point of a wireless network and identifies the performance of the communication operation of the communication unit.

11. A control method of a computer system including a communication unit receiving operating power and performing a network communication operation with an external device, the control method comprising:
determining whether or not the communication unit performs a communication operation, and
controlling the amount of the operating power supplied to the communication unit by reducing an amount of the operating power supplied to the communication unit when the communication unit does not perform the communication operation, and by not reducing the amount of the operating power supplied to the communication unit when the communication unit performs the communication operation.

12. The control method according to claim 11, wherein the operating power of the communication unit is supplied under a power management mode, and
the controlling the communication unit comprises activating the power management mode to reduce the amount of operating power supplied to the communication unit and inactivating the power management mode not to reduce the amount of the operating power supplied to the communication unit.

13. The control method according to claim 12, wherein the communication unit performs the communication operation utilizing a peripheral component interconnect express (PCI-E-bus, and the power management mode comprises an active state power management (ASPM) mode.

14. The control method according to claim 11, further comprising providing a battery for supplying the operating power to the communication unit.

15. The control method according to claim 11, wherein the communication unit performs a wired network communication with an external device, and
determining the performance of the communication operation of the communication unit comprises determining whether or not a cable is connected to the communication unit to perform the wired network communication.

16. The control method according to claim 11, wherein the communication unit performs a wireless network communication with an external device, and
the determining the performance of the communication operation of the communication unit comprises determining whether the communication unit is connected to an access point of a wireless network.
